(19) United States
(12) Patent Application Publication
(10) Pub. No.: US 2005/0102126 A1
(43) Pub. Date: May 12, 2005

(54) Control logic simulation-verification method and simulation-verification personal computer

(76) Inventors: Satoshi Tanaka, Takasago-shi (JP); Isao Sagawa, Takasago-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/673,574

(22) Filed: Sep. 30, 2003

(30) Foreign Application Priority Data
Oct. 10, 2002 (JP) 2002-296977

(51) Int. Cl. G05D 17/00

(52) U.S. Cl. 703/18; 700/286

(57) ABSTRACT

A simulation-verification personal computer comprises a control device simulating simulator personal computer, and a plant model simulator personal computer. The control device simulating simulator personal computer is loaded with a control logic incorporated into a control device. The plant model simulator person computer is loaded with a plant model logic. Upon receipt of an operation command signal, the control logic sends a control command signal, for controlling the run of a plant, to the plant model logic. Upon receipt of the control command signal, the plant model logic performs a simulated action showing the action status of the plant, and outputs a run status signal showing the action status. Both the control logic and the plant model logic use Linux as their OS, and thus can work simultaneously on the personal computers.

The entire disclosure of Japanese Patent Application No. 2002-296977 filed on Oct. 10, 2002, including specification, claims, drawings and summary, is incorporated herein by reference in its entirety.

### BACKGROUND OF THE INVENTION

1. Field of the Invention

This invention relates to a control logic simulation-verification method, and a simulation-verification personal computer, for example, those designed to be capable of simulation-verification of a control logic, which is incorporated into a control device for controlling a combined cycle power plant, by a general-purpose personal computer.

2. Description of the Related Art

A combined cycle power plant, comprising a gas turbine power plant and a steam turbine power plant combined, is complicated and extensive. Such a combined cycle power plant has its running controlled by a control device.

The control device is loaded with a control logic (run control program), and the control logic controls the run of the combined cycle power plant. The control logic computes an operation command signal (a signal having a command to start, stop, designate power output (MW), make an emergency stop, etc.) issued by an operator and necessary for a power generation run, and a run status signal (a signal showing a turbine rotational speed, a generator output, a valve opening, etc.) outputted from the combined cycle power plant, thereby sending a control command signal (a start-up signal, a shutdown signal, a fuel amount signal, an air amount signal, a valve opening signal, etc.) to the combined cycle power plant so that a run status indicated by the operation command signal is achieved. By exercising such run control, a power generation run responsive to the operation command signal is performed.

The control logic loaded into the control device has so far been a program which works under, for example, RMX, a relatively small and quick operating system (OS). This is because, with the control device, a large logic needs to be executed with a high frequency, and no man-machine interface is necessary.

To verify the control logic loaded into the control device, it has been common practice to connect the control device, which is an actual machine (product equipment), and a simulator loaded with a plant model logic and perform verification of the control logic by simulation. In detail, the plant model logic is software developed by mathematically modeling the equipment characteristics constituting the combined cycle power plant. When a control command signal is received, an action simulating the actual action of the combined cycle power plant is performed under the program, and a run status signal showing the simulated action status is outputted. Thus, if the control device is connected to the simulator, and a run action is performed, then the same run status as when the control device is connected to the actual combined cycle power plant is achieved, so that the control logic can be verified.

The plant model logic loaded into the simulator has hitherto been a program which works under, for example, VAX/VMS, an operating system (OS) with satisfactory man-machine performance. This is because, with the simulator, it suffices to run a necessary logic, and a man-machine interface is required.

According to the conventional technologies, the changing speed of the action status simulated by the plant model logic is the same as the changing speed of the action status of the actual combined cycle power plant. For example, the time from start-up until a rated output run status is reached is identical, whether with the plant model logic or in the actual combined cycle power plant.

In conducting a functional confirmation test after achievement of the rated output run status, the time elapsed between start-up and the rated output run status is long. Thus, a technique is available in which a rated run status is prestored, the stored rated run status is set in the control device and the simulator to set a rated output run status as the initial status in the functional confirmation test, and a simulation-verification action is begun in the rated output run status, whereby the functional confirmation test after the rated output run status is conducted (see, for example, Japanese Unexamined Patent Publication No. 2001-318716). This technique makes it possible to immediately conduct the functional confirmation test after the rated output run status, without requiring the time from start-up until the rated output run status.

However, the conventional technique, by which the control device is actually produced as the actual machine, the control device is connected to the simulator (a computer loaded with the plant model logic), and the logic is executed on the control device to carry out simulation-verification, has posed the following problems:

(1) Simulation-verification is possible only while the control device is placed in a manufacturing factory. That is, a logic of a high degree of finishing cannot be formed until the control device is manufactured. Even if a change in the logic becomes necessary before a trial run because of a change in the way of operation or the like, moreover, simulation-verification cannot be performed using the changed logic.

(3) When simulation-verification is conducted in the factory, a lot of workforce is required for preparatory work, such as connection of cables.

(4) Simulation-verification requires the same amount of time as running the actual plant. That is, verification is time-consuming.

(4) Actions of equipment, which acts instantaneously, cannot be fully confirmed.

(5) Since the OS for the control logic and the OS for the plant model logic are different, both logics cannot be executed at the same time on the same personal computer. If both logics can be run at the same time on the same personal computer, simulation-verification of the control logic can be performed by the personal computer.

### SUMMARY OF THE INVENTION

The present invention has been accomplished in the light of the above-mentioned problems with the earlier technologies. It is the object of the invention to provide a control logic simulation-verification method, which can perform simulation-verification of a control logic by a personal computer, and a simulation-verification personal computer using this method.

A control logic simulation-verification method, according to a first aspect of the present invention, for attaining the above-mentioned object, comprises:
executing a control logic and a plant model logic on a reconfigurable identical operating system,
the control logic being adapted to output, in accordance with an operating status, a control command signal necessary for exercising run control of a plant,
the plant model logic being adapted to perform a simulated action, simulating an action status of the plant, upon receipt of the control command signal, and output a run status signal showing the action status, and
the operating system being usable as a combination of only necessary functional portions.

In the control logic simulation-verification method according to the first aspect of the invention, the control logic may be a program for exercising run control of a combined cycle power plant, the plant model logic may be a program for simulating a running action of the combined cycle power plant, and the operating system is Linux.

A simulation-verification personal computer, according to a second aspect of the present invention, comprises:
a control device simulating simulator personal computer which is loaded with a control logic for outputting, in accordance with an operating status, a control command signal necessary for exercising run control of a plant, and which executes the control logic on a reconfigurable operating system usable as a combination of only necessary functional portions; and
a plant model simulator personal computer which is loaded with a plant model logic for performing a simulated action, simulating an action status of the plant, upon receipt of the control command signal, and outputting a run status signal showing the action status, and which executes the plant model logic on an operating system identical with the operating system.

A simulation-verification personal computer, according to a third aspect of the present invention, comprises:
a control device simulating simulator personal computer which is loaded with a control logic for outputting, in accordance with an operating status, a control command signal necessary for exercising run control of a plant; which is loaded with a computation cycle managing task, provided in a control device, for setting a computation cycle of the control logic; and which executes the control logic in the computation cycle, set by the computation cycle managing task provided in the control device, on a reconfigurable operating system usable as a combination of only necessary functional portions; and
a plant model simulator personal computer which is loaded with a plant model logic for performing a simulated action, simulating an action status of the plant, upon receipt of the control command signal, and outputting a run status signal showing the action status; which is loaded with a computation cycle managing task, provided in a plant model, for setting a computation cycle of the plant model logic; and which executes the plant model logic in the computation cycle, set by the computation cycle managing task provided in the plant model, on an operating system identical with the operating system.

A simulation-verification personal computer, according to a fourth aspect of the present invention, comprises:
a control device simulating simulator personal computer which is loaded with a control logic for outputting, in accordance with an operating status, a control command signal necessary for exercising run control of a plant; which is loaded with a computation cycle managing task, provided in a control device, for setting a computation cycle of the control logic; and which is loaded with storage means, provided in the control device, for storing a computation status of the control logic, and
which executes the control logic in the computation cycle, set by the computation cycle managing task provided in the control device, on a reconfigurable operating system usable as a combination of only necessary functional portions; and which can execute the control logic from the computation status stored in the storage means provided in the control device; and
a plant model simulator personal computer which is loaded with a plant model logic for performing a simulated action, simulating an action status of the plant, upon receipt of the control command signal, and outputting a run status signal showing the action status; which is loaded with a computation cycle managing task, provided in a plant model, for setting a computation cycle of the plant model logic; and which is loaded with storage means, provided in the plant model, for storing a computation status of the plant model logic, and
which executes the plant model logic in the computation cycle, set by the computation cycle managing task provided in the plant model, on an operating system identical with the operating system; and which can execute the plant model logic from the computation status stored in the storage means provided in the plant model.

In the simulation-verification personal computer according to any one of the second to fourth aspects of the invention, the control logic may be a program for exercising run control of a combined cycle power plant, the plant model logic may be a program for simulating a running action of the combined cycle power plant, and the operating system may be Linux.

Because of the foregoing features, the present invention shows the following effects:

(1) No matter what stage of the manufacturing process the control device is in, simulation-verification of the control logic can be performed at any time. Thus, the control logic of a high degree of finishing can be produced during the manufacturing process. Even if an operational change is made before a trial run, the control device can be provided to the location of the plant after confirmation of simulation.

(2) Simulation-verification at the manufacturing factory becomes unnecessary, and the amount of work by workers can be reduced markedly.

(3) The settings are all managed as “a data file” on the personal computer. Once the settings are made, simulation-verification can be performed easily at any time (even after shipment of the control device).

(4) Without the use of the control device, simulation-verification can be performed, and work time for measurements can be shortened.

(5) Connection and disconnection of cables between the control device and the simulator are unnecessary. During simulation-verification of the control logic, workers in charge of measurements need not participate.

(6) By adjusting the computation cycle, an action of equipment working instantaneously can be verified by simulation over a prolonged time. An action of equipment working over a long time can be verified by simulation over a shortened time.

### BRIEF DESCRIPTION OF THE DRAWING

The present invention will become more fully understood from the detailed description given hereinbelow and the accompanying drawing which is given by way of illustration only, and thus is not limitative of the present invention, and wherein:

FIG. 1 is a block diagram showing a simulation-verification personal computer according to an embodiment of the present invention.

### DESCRIPTION OF THE PREFERRED EMBODIMENTS

Preferred embodiments of the present invention will now be described in detail by reference to the accompanying drawing, but in no way limit the invention.

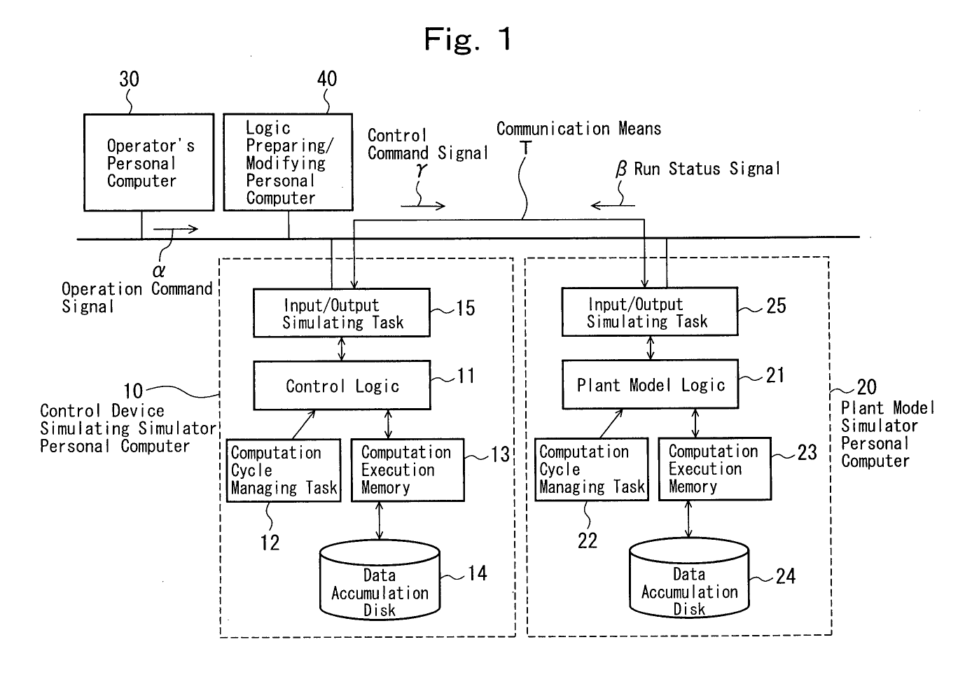

FIG. 1 shows a simulation-verification personal computer according to an embodiment of the present invention. As shown in the drawing, this simulation-verification personal computer is composed of a control device simulating simulator personal computer 10, a plant model simulator personal computer 20, an operator's personal computer 30, and a logic preparing/modifying personal computer 40. These personal computers 10 to 40 are connected by communication means (communication line, etc.).

The control device simulating simulator personal computer 10 is loaded with a control logic 11, which is the same as that loaded into a control device as an actual machine. The control logic 11 is prepared by the logic preparing/modifying personal computer 40, transferred to the control device simulating simulator personal computer 10, and loaded there. The control logic (run control program) 10 is a program working under a reconfigurable operating system (OS) usable as a combination of necessary functional portions, such as, for example, Linux.

The control logic 11 computes an operation command signal α sent from the operator's personal computer 30, and a run status signal β sent from the plant model simulator personal computer 20, thereby sending a control command signal γ, for bringing the run status to that indicated by the operation command signal α, to the plant model simulator personal computer 20.

The operation command signal α includes signals showing commands to start, stop, designate power output (MW), make an emergency stop, etc. The run status signal β includes signals showing a turbine rotational speed, a generator output, a valve opening, etc. The control command signal γ includes a start-up signal, a shutdown signal, a fuel amount signal, an air amount signal, a valve opening signal, etc.

A computation cycle managing task 12, loaded into the control device simulating simulator personal computer 10, sets the computation cycle of the control logic 11. The computation cycle managing task 12 sets the computation cycle such that computation is performed every 50 msec like the actual machine (control device). Where necessary, however, the computation cycle managing task 12 can set the computation cycle to be shorter or longer. Hence, the control logic 11 performs computation periodically in the computation cycle set by the computation cycle managing task 12. The computation cycle can be set under the command of a person who operates the control device simulating simulator personal computer 10.

The control device simulating simulator personal computer 10 is loaded with a computation execution memory 13 and a data accumulation disk 14. Under the command of the person who operates the control device simulating simulator personal computer 10, present data within the computation execution memory 13 can be accumulated into the data accumulation disk 14, or the accumulated data can be transferred into the computation execution memory 13. By transferring the data accumulated in the data accumulation disk 14 into the computation execution memory 13, the control logic can be executed halfway through run control, for example, after a point in time when a rated output run is established.

An input/output simulating task 15 loaded into the control device simulating simulator personal computer 10 is a task which simulates the same functions as those of the input/output device of the actual machine through communication.

The plant model simulator personal computer 20 is loaded with a plant model logic 21. The plant model logic 21 is prepared by the logic preparing/modifying personal computer 40, transferred to the plant model simulator personal computer 20, and loaded there. The plant model logic 21 is a program working under a reconfigurable operating system (OS) usable as a combination of necessary functional portions, such as, for example, Linux.

The plant model logic 21 is software developed by mathematically modeling equipment characteristics constituting the combined cycle power plant. When a control command signal γ is received, an action simulating the action of the actual combined cycle power plant is performed under the program, and a run status signal β showing the simulated action status is outputted. The run status signal β includes signals showing a turbine rotational speed, a generator output, a valve opening, etc.

A computation cycle managing task 22, loaded into the plant model simulator personal computer 20, sets the computation cycle of the plant model logic 21. The computation cycle managing task 22 sets the computation cycle at about 10 msec so that a status similar to that in the actual machine (combined cycle power plant) can be simulated. Where necessary, however, the computation cycle managing task 22 can set the computation cycle to be shorter or longer. Hence, the plant model logic 21 performs computations periodically in the computation cycle set by the computation cycle managing task 22. The computation cycle can be set under the command of a person who operates the plant model simulator personal computer 20.

The plant model simulator personal computer 20 is loaded with a computation execution memory 23 and a data accumulation disk 24. Under the command of the person who operates the plant model simulator personal computer 20, present data within the computation execution memory 23 can be accumulated into the data accumulation disk 24, or the accumulated data can be transferred into the computation execution memory 23. By transferring the data accumulated in the data accumulation disk 24 into the computation execution memory 23, an action simulating the action of the combined cycle power plant can be performed halfway through the run action, for example, after a point in time when a rated output run is established.

An input/output simulating task 25 loaded into the plant model simulator personal computer 20 is a task which simulates the same functions as those of an input/output device of the actual machine through communication.

Communication (sending and receiving of data) between the control logic 11 and the plant model logic 21 is established by wired or wireless communication means T.

The operator's personal computer 30 is a man-machine interface with which an operator runs and operates the plant. This computer 30 can output the operation command signal α by the same operating method as that for the actual machine (operating panel), and can display the same screen as in the actual machine (operating panel). Thus, the operator can perform an operating action by the same operating method as for the actual machine (operating panel), and does not need to memorize dedicated commands or operating methods. The operation command signal α includes signals showing commands to start, stop, designate power output (MW) make an emergency stop, etc.

The logic preparing/modifying personal computer 40 is adapted to prepare the control logic 11 and the plant model logic 21. If simulation-verification (to be described later) detects the occurrence of a bug in the control logic 11 or the plant model logic 21, the logic preparing/modifying personal computer 40 carries out debugging and fixes or modifies the program (logic).

With the simulation-verification personal computer having the foregoing features, when the operation command signal α is outputted from the operator's personal computer 30, the control logic 11 of the control device simulating simulator personal computer 10 outputs the control command signal γ in response to the operation command signal α, and a plant simulating action responsive to the control command signal γ is performed under a program by the plant model logic 21 of the plant model simulator personal computer 20. The run status signal β showing the status of the plant simulating action is sent from the plant model logic 21 to the control logic 11.

By examining whether the run status signal β follows a course as indicated by the operation command signal α during such a simulation run, the control logic 11 can be verified.

In this case, both the control logic 11 and the plant model logic 21 can be executed at the same time by the personal computers 10, 20, because they are programs working under Linux, a reconfigurable operating system (OS) usable as a combination of only necessary functional portions.

Furthermore, slow-motion simulation-verification or high-speed simulation-verification can be carried out by changing the computation cycle of the control logic 11 with the use of the computation cycle managing task 12, and changing the computation cycle of the plant model logic 21 with the use of the computation cycle managing task 22.

In performing simulation-verification in slow motion, the computation cycles of the control logic 11 and the plant model logic 21 are set to be long. By setting such long computation cycles, a state where the plant appears to be run slowly can be created.

A series of motions of the actual machine in which valve opening and closing actions are repeated one after another within several seconds, such as purge sequence of a gas turbine, cannot be checked with the unaided eye of a human. Setting such long computation cycles in slow-motion simulation-verification, however, enables a human naked eye to track such motions. The computation cycle increased to 10 times the steady cycle, for example, changes a valve opening/closing action lasting 10 seconds to a valve opening/closing action lasting 100 seconds. This action can be confirmed even with the unaided eye.

Sampling is performed at intervals of the computation time set to be long, and records are taken at the same time intervals as the computation cycle in the actual machine. Thus, data to be recorded into the data accumulation disks 14, 24 are recorded into them at the same points in time as in the actual machine, so that the same simulation-verification data as would be recorded in the computation cycle of the actual machine can be retained.

In performing simulation-verification at a high speed, the computation cycles of the control logic 11 and the plant model logic 21 are set to be long. By setting such long computation cycles, a state where the plant appears to be run quickly can be created.

In the case of a cold start, a steam control valve in the actual machine is opened slowly, such as at a rate of 1%/min. Thus, verification takes several hours, during which there are no important items to be checked, and the same action is simply repeated. With high-speed verification involving such short set computation cycles, however, the duration of cold start can be shortened. For example, the computation cycle shortened to 1/10 of the steady cycle can result in a decrease of the cold start time to 1/10.

Sampling is performed at intervals of the computation time set to be short, and records are taken at the same time intervals as the computation cycle in the actual machine. Thus, data to be recorded into the data accumulation disks 14, 24 are recorded into them at the same points in time as in the actual machine, so that the same data as would be obtained by simulation-verification in the computation cycle of the actual machine can be retained.

Once the data are accumulated in the data accumulation disks 14, 24, the data existing halfway through the simulation are transferred into the computation execution memories 13, 23, whereby a control logic action and a plant simulating action can be performed halfway through run control and a running action. That is, simulation-verification can be initiated from the necessary state.

Conventional simulation of load shutdown, for example, has required that a simulation action be performed, with the gas turbine being operated from the start. About 1 hour has been taken until a rated run status, meaning a loss of time.

With the present invention, by contrast, the simulation data are accumulated, and the accumulated data are always ready for withdrawal. Thus, simulation-verification can be conducted halfway through run control and run action.

Thus, data under a full load of the gas turbine are accumulated. When load shutdown simulation-verification is to be performed, the accumulated data are withdrawn, and a full-load status can be immediately created. Thus, load shutdown simulation can be started without a loss of time.

In the embodiment shown in FIG. 1, the control device simulating simulator personal computer 10 and the plant model simulator personal computer 20 are used. However, the functions loaded into both personal computers 10 and 20 and the functions of the communication means T can be loaded into a single personal computer to perform simulation-verification of the control logic 11. This is because both the control logic 11 and the plant model logic 21 are programs working under Linux, the reconfigurable operating system (OS) usable as a combination of necessary functional portions, and thus the logics 11, 21 can be run at the same time on a single personal computer under the same OS.

In the embodiment of FIG. 1, moreover, the control device simulating simulator personal computer 10 is loaded with only the portions necessary for computation. This personal computer can also be used as a training simulator by loading it with a man-machine portion for use in a training simulator.

That is, a training simulator and a control device have so far been constructed by completely different types of hardware. Thus, the control logic for use in the training simulator needs to be constructed newly, separately from the logic for the control device. If, for example, Linux, the reconfigurable operating system (OS) usable as a combination of necessary functional portions, is used as OS for the control logic, the portion common to the logic for the control device and the logic for the training simulator can be shared. Thus, the production time for the training simulator can be shortened.

While the present invention has been described in the foregoing fashion, it is to be understood that the invention is not limited thereby, but may be varied in many other ways. Such variations are not to be regarded as a departure from the spirit and scope of the invention, and all such modifications as would be obvious to one skilled in the art are intended to be included within the scope of the appended claims.

1. A control logic simulation-verification method, comprising:
executing a control logic and a plant model logic on a reconfigurable identical operating system,
said control logic being adapted to output, in accordance with an operating status, a control command signal necessary for exercising run control of a plant,
said plant model logic being adapted to perform a simulated action, simulating an action status of the plant, upon receipt of said control command signal, and output a run status signal showing the action status, and
said operating system being usable as a combination of only necessary functional portions.

2. The control logic simulation-verification method according to claim 1, wherein said control logic is a program for exercising run control of a combined cycle power plant, said plant model logic is a program for simulating a running action of the combined cycle power plant, and said operating system is Linux.

3. A simulation-verification personal computer, comprising:
a control device simulating simulator personal computer which is loaded with a control logic for outputting, in accordance with an operating status, a control command signal necessary for exercising run control of a plant, and which executes said control logic on a reconfigurable operating system usable as a combination of only necessary functional portions; and
a plant model simulator personal computer which is loaded with a plant model logic for performing a simulated action, simulating an action status of the plant, upon receipt of said control command signal, and outputting a run status signal showing the action status, and which executes said plant model logic on an operating system identical with said operating system.

4. A simulation-verification personal computer, comprising:
a control device simulating simulator personal computer which is loaded with a control logic for outputting, in accordance with an operating status, a control command signal necessary for exercising run control of a plant; which is loaded with a computation cycle managing task, provided in a control device, for setting a computation cycle of said control logic; and which executes said control logic in said computation cycle, set by said computation cycle managing task provided in the control device, on a reconfigurable operating system usable as a combination of only necessary functional portions; and
a plant model simulator personal computer which is loaded with a plant model logic for performing a simulated action, simulating an action status of the plant, upon receipt of said control command signal, and outputting a run status signal showing the action status; which is loaded with a computation cycle managing task, provided in a plant model, for setting a computation cycle of said plant model logic; and which executes said plant model logic in said computation cycle, set by said computation cycle managing task provided in the plant model, on an operating system identical with said operating system.

5. A simulation-verification personal computer, comprising:
a control device simulating simulator personal computer which is loaded with a control logic for outputting, in accordance with an operating status, a control command signal necessary for exercising run control of a plant; which is loaded with a computation cycle managing task, provided in a control device, for setting a computation cycle of said control logic; and which is loaded with storage means, provided in the control device, for storing a computation status of said control logic, and
which executes said control logic in said computation cycle, set by said computation cycle managing task provided in the control device, on a reconfigurable operating system usable as a combination of only necessary functional portions; and which can execute said control logic from said computation status stored in said storage means provided in the control device; and
a plant model simulator personal computer which is loaded with a plant model logic for performing a simulated action, simulating an action status of the plant, upon receipt of said control command signal, and outputting a run status signal showing the action status; which is loaded with a computation cycle managing task, provided in a plant model, for setting a computation cycle of said plant model logic; and which is loaded with storage means, provided in the plant model, for storing a computation status of said plant model logic, and
which executes said plant model logic in said computation cycle, set by said computation cycle managing task provided in the plant model, on an operating system identical with said operating system; and which can execute said plant model logic from said computation status stored in said storage means provided in the plant model.

6. The simulation-verification personal computer according to claim 3, wherein said control logic is a program for exercising run control of a combined cycle power plant, said plant model logic is a program for simulating a running action of the combined cycle power plant, and said operating system is Linux.

7. The simulation-verification personal computer according to claim 4, wherein said control logic is a program for exercising run control of a combined cycle power plant, said plant model logic is a program for simulating a running action of the combined cycle power plant, and said operating system is Linux.

8. The simulation-verification personal computer according to claim 5, wherein said control logic is a program for exercising run control of a combined cycle power plant, said plant model logic is a program for simulating a running action of the combined cycle power plant, and said operating system is Linux.
